(19) United States
(12) Patent Application Publication
(10) Pub. No.: US 2005/0129362 A1
(43) Pub. Date: Jun. 16, 2005

(54) Mitigation of stimulated brillouin scattering in electromagnetic waveguides using wavelenght-selective mirrors

(75) Inventors: Govind P. Agrawal, Rochester, NY (US); Hojoon Lee, Choongnam (KR)

Correspondence Address: DEMONT & BREYER, LLC, SUITE 250, 100 COMMONS WAY, HOLMDEL, NJ, 07733, US

(73) Assignee: University of Rochester, Rochester, NY (US)

(21) Appl. No.: 11/011,292

(22) Filed: Dec. 14, 2004

Related U.S. Application Data
(60) Provisional application No. 60/529,876, filed on Dec. 16, 2003.

(51) Int. Cl. G02B 6/34

(52) U.S. Cl. 385/37; 385/24

(57) ABSTRACT

A mechanism for mitigating the effects of Stimulated Brillouin Scattering in electromagnetic waveguides such as optical fibers is disclosed. In particular, the illustrative embodiment of the present invention incorporates a plurality of evenly-spaced wavelength-selective mirrors, such as fiber Bragg gratings, into the waveguide that are designed to convey a forward-propagating incident wave and to reflect the backward-propagating Stokes wave induced by the incident wave. This prevents the build up of the backward-propagating Stokes wave and mitigates the deleterious effects of Stimulated Brillouin Scattering

### CROSS-REFERENCE TO RELATED APPLICATION

This application claims the benefit of U.S. provisional application Ser. No. 60/529,876, filed 16 Dec. 2003, entitled “Suppression of Stimulated Brillouin Scattering in Optical Fibers Using Fiber Bragg Gratings,” (Attorney Docket: 315-003us), which is incorporated by reference.

### FIELD OF THE INVENTION

The present invention relates to optics in general, and, more particularly, to techniques for mitigates the effects of Stimulated Brillouin Scattering in electromagnetic waveguides such as optical fibers.

### BACKGROUND OF THE INVENTION

Stimulated Brillouin scattering occurs when the signal power in an optical fiber reaches a level that can generate acoustic vibration in the glass, corresponding to powers as low as a few milliwatts in the small cores of single-mode fiber. Acoustic waves change the density of a material and thus alter its refractive index. The resulting fluctuations in refractive index can scatter light; this effect is called Brillouin scattering. Because the light wave being scattered itself generates the acoustic waves, the process in fibers is called stimulated Brillouin scattering.

In single-mode fibers, stimulated Brillouin scattering is manifested as the generation of a backward-propagating Stokes wave, downshifted slightly in frequency from the original light wave. (For example, the frequency shift is 11 GHz, or slightly less than 0.1 nanometers, for an incident wave that has a wavelength of 1500 nm.) The scattered wave goes back toward the transmitter, and increases in intensity along the length of the fiber due to accumulation of stimulated Brillouin scattering. The effect is strongest when the light pulse is long (allowing a long interaction between light and the acoustic wave), and the laser linewidth is very small, around 100 MHz. Under continuous-wave conditions, it can occur at power levels as little as 3 mW for sufficiently long fibers.

Brillouin scattering reduces signal strength by directing part of the light back toward the transmitter, effectively increasing attenuation. Careful design can reduce the impact of Brillouin scattering, but Brillouin scattering sets an upper limit for power levels in systems using narrow-linewidth laser sources. The strength of the effect of Brillouin scattering can increase with the number of optical amplifiers in a system. Optical isolators can be added to block light from going toward the transmitter to block that increase, but at the cost of added system complexity and expense.

Stimulated Brillouin scattering has been studied extensively in the context of optical communications systems, but it also impacts the performance of high-power fiber lasers and amplifiers designed to generate Q-switched pulses with high energies. Although fiber lengths are not very large in the case of fiber lasers and amplifiers, the peak power of a Q-switched pulse can exceed 10 kW. The effects of stimulated Brillouin scattering can be mitigated, to some extent, by reducing pulse duration below 10-20 nanoseconds; however, the transient nature of stimulated Brillouin scattering continues to play an important role for such short pulses.

### SUMMARY OF THE INVENTION

The present invention provides a mechanism for mitigating the effects of Stimulated Brillouin Scattering in electromagnetic waveguides such as optical fibers without some of the costs and disadvantages for doing so in the prior art.

In particular, the illustrative embodiment of the present invention incorporates a plurality of evenly-spaced wavelength-selective mirrors, such as fiber Bragg gratings, into the waveguide that are designed to convey a forward-propagating incident wave and to reflect the backward-propagating Stokes wave induced by the incident wave. This prevents the build up of the backward-propagating Stokes wave and mitigates the deleterious effects of Stimulated Brillouin Scattering.

The illustrative embodiment of the present invention comprises: an electromagnetic waveguide that is capable of transporting a first electromagnetic wave in one direction and a second electromagnetic wave in the opposite direction, wherein the second electromagnetic wave is stimulated by the first electromagnetic wave; and an wavelength-selective mirror in the electromagnetic waveguide that reflects the second electromagnetic wave more than the first electromagnetic wave.

### BRIEF DESCRIPTION OF THE DRAWINGS

FIG. 1 depicts a block diagram of the salient components of a telecommunications system in accordance with the illustrative embodiment of the present invention.

FIG. 2A depicts a representational drawing of the salient aspects of optical fiber 200-A in accordance with the illustrative embodiment.

FIG. 2B depicts a representational drawing of the salient aspects of optical fiber 200-B, which is an optical fiber in accordance with some embodiments of the present invention.

FIG. 2C depicts a representational drawing of the salient aspects of optical fiber 200-C, which is an optical fiber in accordance with some embodiments of the present invention.

FIG. 3 depicts an enlarged representational drawing of the salient aspects of optical fiber 200-B.

FIG. 4A depicts a graphical representation of the intensity of a Stokes wave in optical fiber 202A as it increases in intensity in the five sections separated by the three fiber Bragg gratings.

FIG. 4B depicts a graphical representation of the intensity of a Stokes wave in an optical fiber comprising a single fiber Bragg grating, located near the transmitter end of the optical fiber.

FIG. 5 depicts a schematic drawing of the salient aspects of a fiber laser in accordance with some embodiments of the present invention.

### DETAILED DESCRIPTION

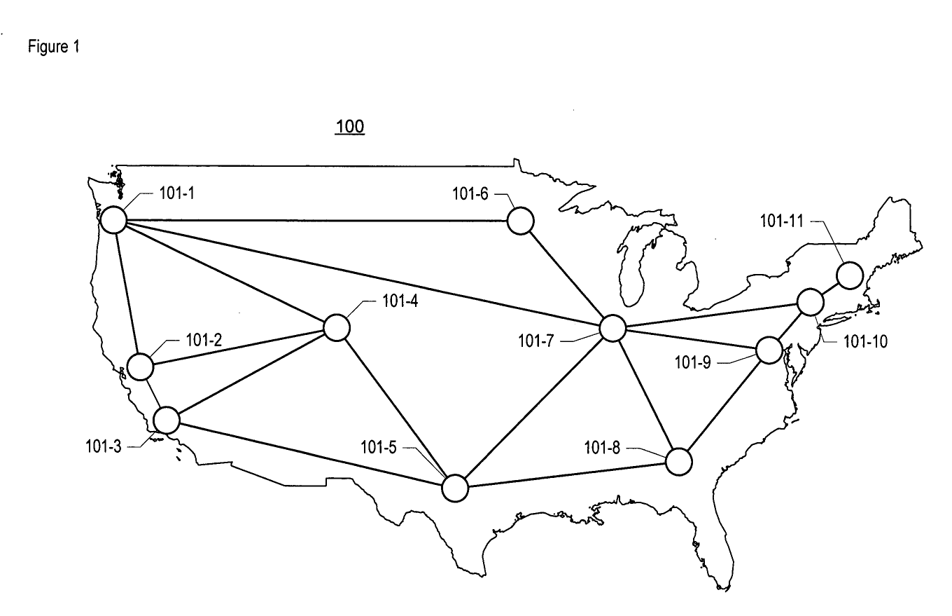

FIG. 1 depicts a block diagram of the salient components of a telecommunications system in accordance with the illustrative embodiment of the present invention. Telecommunications system 100 comprises eleven geographically-distributed telecommunications switches 101-1 through 101-11 and a plurality of electromagnetic waveguides that interconnect some pairs of telecommunications switches. The ability of telecommunications system 100 to operate is based upon, among other things, the ability of the electromagnetic waveguides to carry electromagnetic waves from one telecommunications switch to another without much loss or distortion.

In accordance with the illustrative embodiment, the electromagnetic waveguides are optical fibers. It will be clear to those skilled in the art, however, after reading this disclosure, how to make and use alternative embodiments of the present invention in which the electromagnetic waveguides are something other than optical fibers (e.g., metallic co-axial cable, microstrip transmission lines, etc.).

In accordance with the illustrative embodiment, each of telecommunications switches 101-1 through 101-11 uses a high-power laser to transmit a 1550 nm-wavelength optical bit stream with more than 10 mW of average power in an optical fiber. Many telecommunications systems in the prior art use lasers of significantly less power. In this case, the high-power wave is advantageous because it provides a high signal-to-noise ratio at the receiver and does not need to be re-generated in such a short distance as a lower-power wave.

It will be clear to those skilled in the art, after reading this specification, how to make and use alternative embodiments of the present invention that use lasers of different powers and pulses of different widths. Furthermore, it will be clear to those skilled in the art, after reading this specification, how to make and use alternative embodiments of the present invention that transmit an optical wave with any wavelength.

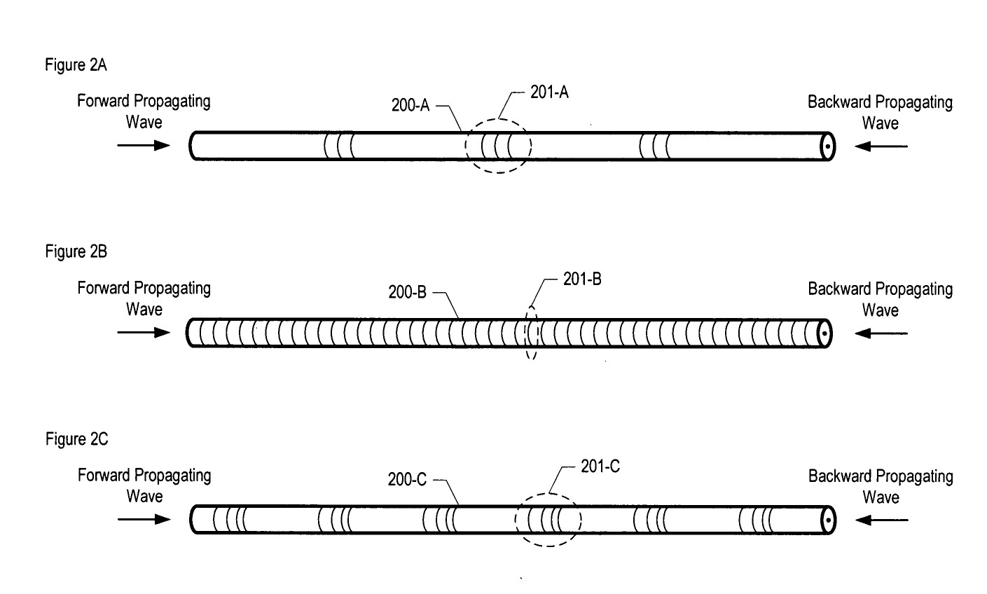

As is well-known to those skilled in the art, the high-power optical wave induces Stimulated Brillouin Scattering in the optical fibers, which manifests itself as a backward-propagating Stokes wave, downshifted in frequency, in the direction opposite to the inducing wave. The illustrative embodiment of the present invention mitigates the effect of Stimulated Brillouin Scattering by inserting a wavelength-selective mirror in the optical fiber, as depicted in FIG. 2A through 2C.

FIG. 2A depicts a representational drawing of the salient aspects of optical fiber 200-A, in accordance with the illustrative embodiment of the present invention. Optical fiber 200-A is capable of transporting a forward-propagating incident wave in a forward direction and of transporting the backward-propagating Stokes wave in the backward direction.

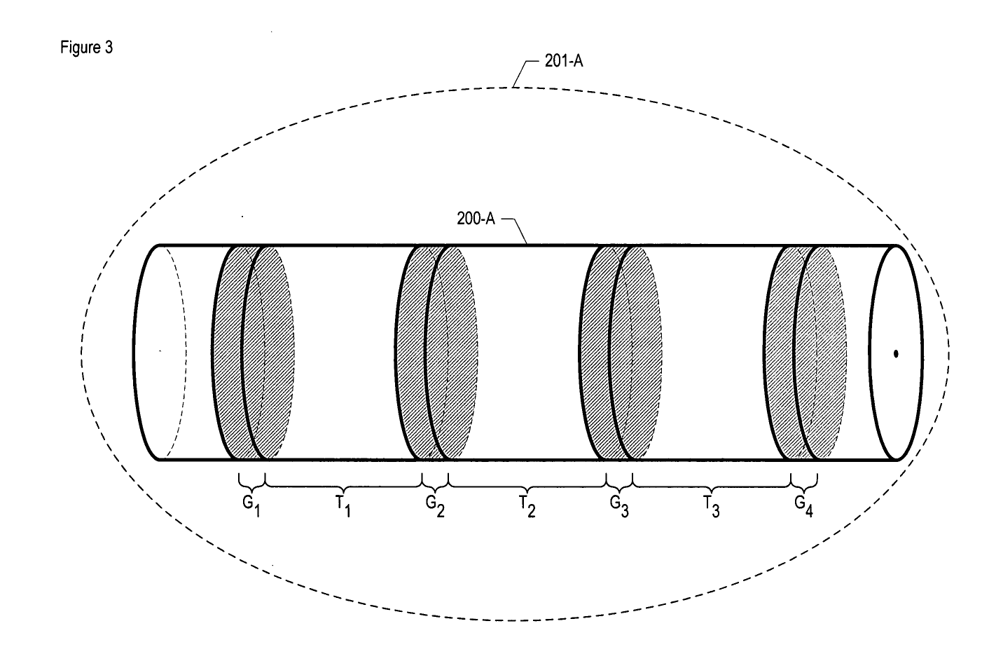

Optical fiber 200-A comprises a plurality of evenly-spaced fiber Bragg gratings, such as fiber Bragg grating 201-A, along the entire length of optical fiber 200-A and that reflects the backward-propagating Stokes wave more than it does the forward-propagating incident optical wave (i.e., the coupling coefficient of the grating is greater for the backward-propagating Stokes wave than the forward-propagating incident optical wave). The number of and spacing between fiber Bragg gratings 201-A governs the intensity of the backward-propagating Stokes wave that exists in optical fiber 200-A. Although the illustrative embodiment comprises six fiber Bragg gratings, it will be clear to those skilled in the art, after reading this specification, how to make and use alternative embodiments of the present invention that comprise any number of fiber Bragg gratings. The details of optical fiber 200-A are described in detail below and with respect to FIG. 3.

FIG. 2B depicts a representational drawing of the salient aspects of optical fiber 200-B in accordance with some alternative embodiments of the present invention. Optical fiber 200-B is capable of transporting a forward-propagating incident wave in a forward direction and of transporting the backward-propagating Stokes wave in the backward direction.

Optical fiber 200-B comprises a wavelength-selective mirror that reflects the backward-propagating Stokes wave more than it does the forward-propagating incident optical wave. In particular, the wavelength-selective mirror is a fiber Bragg grating that comprises a plurality grating elements 201-B along the entire length of the optical fiber 200-A. It will be clear to those skilled in the art how to make and use optical fiber 200-B and grating elements 201-B for any wavelength and power of incident wave.

Optical fiber 200-B is more expensive to manufacture than optical fiber 200-A because it comprises more Bragg grating elements, but might be, in some cases, more effective than optical fiber 200-A in mitigating the Stimulated Brillouin Scattering. In any case, it will be clear to those skilled in the art how to make and use optical fiber 200-B and fiber Bragg grating 200-B for any wavelength and power of incident wave.

FIG. 2C depicts a representational drawing of the salient aspects of optical fiber 200-C, which is an optical fiber in accordance with some embodiments of the present invention. Optical fiber 200-C is capable of transporting a forward-propagating incident wave in a forward direction and of transporting the backward-propagating Stokes wave in the backward direction.

Optical fiber 200-C comprises a plurality of evenly-spaced chirped fiber Bragg gratings, such as chirped fiber Bragg grating 201-C, that reflects the backward-propagating Stokes wave more than it does the forward-propagating incident optical wave. As is well known to those skilled in the art, chirped fiber Bragg grating 201-C has a broader bandwidth than a non-chirped fiber Bragg grating. In any case, it will be clear to those skilled in the art, after reading this disclosure, how to make and use optical fiber 200-C and chirped fiber Bragg grating 200-C for any wavelength and power of incident wave.

FIG. 3 depicts an enlarged representational drawing of the salient aspects of fiber Bragg grating 201-A, in accordance with the illustrative embodiment of the present invention. FIG. 3 depicts four grating elements G₁ through G₄ that are interleaved with three transmissive elements T₁ through T₃, as shown. Each grating element and transmissive element has a width and an index of refraction that is designed to block the backward-propagating Stokes wave and yet pass the forward-propagating incident wave.

It will be clear to those skilled in the art how to determine the wavelength of the backward-propagating Stokes wave based on the wavelength, modulation rate, and power of the forward-propagating incident wave. Furthermore, it will be clear to those skilled in the art how to make and use fiber Bragg grating 201-A for any wavelength of Stoke wave and incident wave.

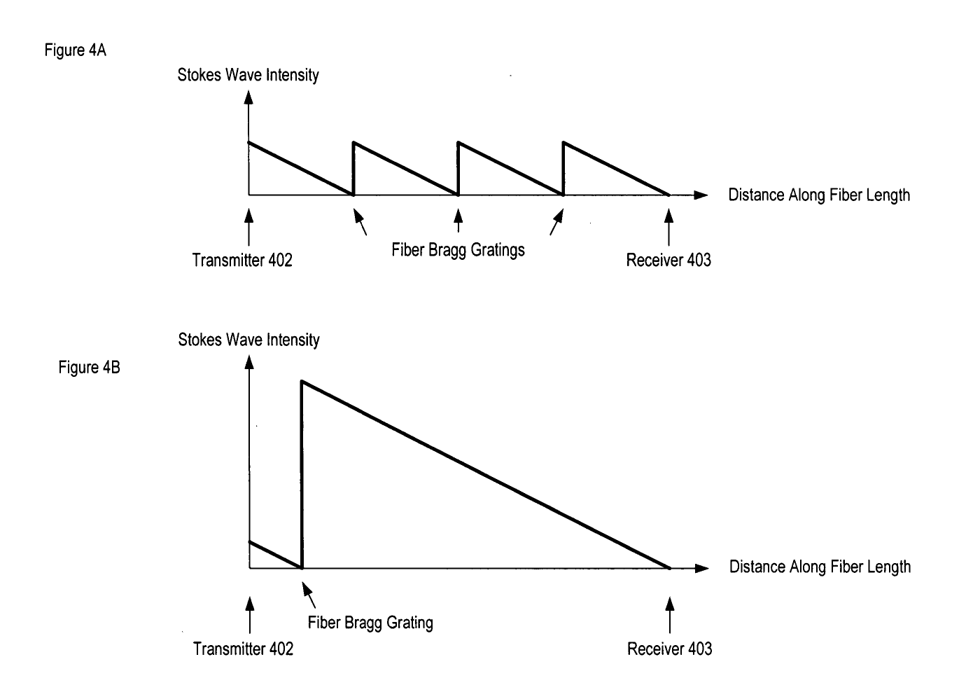

FIG. 4A depicts a graphical representation of the intensity of a Stokes wave in optical fiber 202A as it increases in intensity in the five sections separated by the three fiber Bragg gratings. At each fiber Bragg grating, the backward-propagating Stokes wave is reflected, thereby halting its accumulation in the backward-propagating direction and suppressing its intensity.

FIG. 4B depicts a graphical representation of the intensity of a Stokes wave in an optical fiber comprising a single fiber Bragg grating, located near the transmitter end of the optical fiber. Due to the longer length of optical fiber in which the backward-propagating Stokes wave accumulates, the intensity level of the Stokes wave reaches a higher level than that shown in FIG. 4A. In order to suppress the intensity of the Stokes wave, therefore, the coupling coefficient (a function of the grating modulation depth, grating length, grating period, and grating element width) of the fiber Bragg grating is higher than in the distributed grating case.

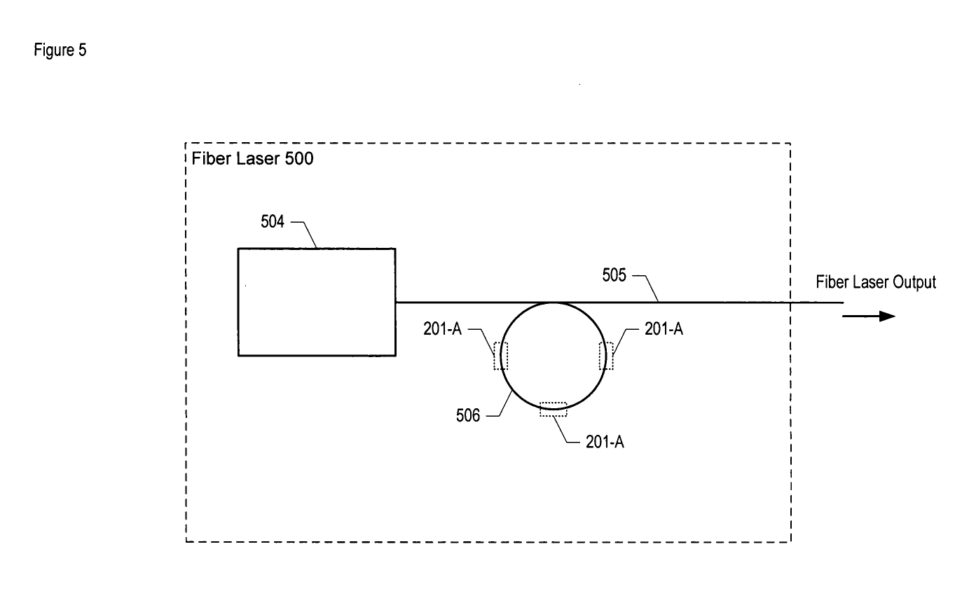

FIG. 5 depicts a schematic drawing of the salient aspects of a fiber laser in accordance with some embodiments of the present invention. Fiber laser 500 comprises Q-switched laser 504, optical fiber 505, amplification fiber coil 506, and a plurality of evenly-spaced fiber Bragg gratings 201-A.

Q-switched laser 504, which operates at 1053 nanometer wavelength, launches optical pulses into optical fiber 505. Amplification fiber coil 506, which is a one-meter long optical fiber that is doped with ytterbium, is coupled to optical fiber 505 such that it provides optical gain to the optical power launched at the fiber laser output. Fiber Bragg gratings 201-A suppress stimulated Brillouin scattering in amplification fiber coil 506, thereby enabling the peak power of the amplified pulses to exceed 1 kW.

It will be clear to those skilled in the art, after reading this specification, how to make and use alternative embodiments of the present invention that use amplification fiber coils that are doped with materials other than ytterbium, such as erbium, yttrium, lanthanum, samarium, cerium, praseodymium, neodymium, promethium, europium, terbium, holmium, or thulium. Furthermore, it will be clear to those skilled in the art, after reading this specification, how to make and use alternative embodiments of the present invention that use amplification fiber coils of any length. And still furthermore, it will be clear to those skilled in the art, after reading this specification, how to make and use alternative embodiments of the present invention amplification fiber coil 506 comprises any manner or number of fiber Bragg gratings.

It is to be understood that the illustrative embodiments merely depict some contexts, applications, and combinations of the present inventions and that those skilled in the art can devise many variations of the illustrative embodiments without departing from the scope of one or more of the inventions. It is therefore intended that such variations be included within the scope of the following claims and their equivalents.

1. An apparatus comprising:
an electromagnetic waveguide that is capable of transporting a first electromagnetic wave and a second electromagnetic wave, wherein said second electromagnetic wave is stimulated by said first electromagnetic wave in said electromagnetic waveguide, and wherein said second electromagnetic wave is stimulated to propagate in the direction opposite to the direction of propagation of said first electromagnetic wave; and
a wavelength-selective mirror in said electromagnetic waveguide that reflects said second electromagnetic wave in the direction of propagation of said first electromagnetic wave, and wherein said wavelength-selective mirror reflects said second electromagnetic wave more than said first electromagnetic wave.

2. The apparatus of claim 1 wherein said second electromagnetic wave comprises stimulated Brillouin scattering of said first electromagnetic wave.

3. The apparatus of claim 1 wherein said wavelength-selective mirror comprises a grating.

4. The apparatus of claim 1 wherein said wavelength-selective mirror comprises a Bragg grating.

5. The apparatus of claim 1 wherein said electromagnetic waveguide is an optical fiber.

6. The apparatus of claim 1 wherein said electromagnetic waveguide is an integrated optic surface waveguide.

7. The apparatus of claim 1 wherein said wavelength-selective mirror comprises a plurality of gratings and wherein said gratings are equally-spaced in said electromagnetic waveguide.

8. The apparatus of claim 1 wherein said wavelength-selective mirror is sufficient to reduce the intensity of said second electromagnetic wave below a threshold in all portions of said electromagnetic waveguide.

9. An apparatus comprising:
a first plurality of transmissive elements having a first refractive index; and
a second plurality of transmissive elements having a second refractive index; wherein said first plurality of transmissive elements and said second plurality of transmissive elements are interleaved; and
wherein the combination of said first plurality of transmissive elements and said second plurality of transmissive elements is substantially transparent to a first electromagnetic wave and is substantially reflective to a second electromagnetic wave created by the Brillouin scattering stimulated by said first electromagnetic wave.

10. The apparatus of claim 9 wherein the ratio of said first refractive index and said second refractive index is a function of the wavelength and intensity of said first electromagnetic wave.

11. The apparatus of claim 11 wherein the ratio of said first refractive index and said second refractive index is a function of the wavelength of said second electromagnetic wave.

12. The apparatus of claim 9 wherein each of said first plurality of transmissive elements has a first thickness, and wherein each of said second plurality of transmissive elements has a second thickness, and wherein the ratio of the first thickness to the second thickness is a function of the wavelength and intensity of said first electromagnetic wave.

13. The apparatus of claim 12 wherein each of said first plurality of transmissive elements has a first thickness, and wherein each of said second plurality of transmissive elements has a second thickness, and wherein the ratio of the first thickness to the second thickness is a function of the wavelength of said second electromagnetic wave.

14. The apparatus of claim 9 wherein each of said first plurality of transmissive elements has a thickness that is a function of the wavelength and intensity of said first electromagnetic wave.

15. The apparatus of claim 14 wherein each of said first plurality of transmissive elements has a thickness that is a function of the wavelength of said second electromagnetic wave.

16. The apparatus of claim 9 wherein the number of elements in said first plurality of transmissive elements is a function of the wavelength and intensity of said first electromagnetic wave.

17. The apparatus of claim 16 wherein the number of elements in said first plurality of transmissive elements is a function of the wavelength of said second electromagnetic wave.

18. A telecommunications system comprising:
a first plurality of telecommunications switches; and
a second plurality of optical fibers that interconnect each of said telecommunications switches, wherein each of said optical fibers is capable of transporting a first electromagnetic wave in one direction and a second electromagnetic wave in the opposite direction, and wherein said second electromagnetic wave is created by the Brillouin scattering stimulated by said first electromagnetic wave, and wherein each of said optical fibers comprises an wavelength-selective mirror that reflects said second electromagnetic wave more than said first electromagnetic wave.

19. The apparatus of claim 18 wherein said wavelength-selective mirror comprises a grating.

20. The apparatus of claim 18 wherein said wavelength-selective mirror comprises a Bragg grating.

21. The apparatus of claim 18 wherein said wavelength-selective mirror reverses the direction of at least a portion of said second electromagnetic wave.

22. The apparatus of claim 18 wherein said wavelength-selective mirror comprises a plurality of gratings and wherein said gratings are equally-spaced in said electromagnetic waveguide.

23. The apparatus of claim 22 wherein said wavelength-selective mirror is sufficient to reduce the intensity of said second electromagnetic wave below a threshold in all portions of said electromagnetic waveguide.

24. An apparatus comprising:
a laser source;
a first optical fiber, wherein said optical fiber is doped with a material that enables said first optical fiber to provide optical gain;
a fiber Bragg grating, wherein said fiber Bragg grating moderates stimulated Brillouin scattering in said apparatus; and
a second optical fiber, wherein said second optical fiber comprises an input and an output, and wherein said input of said second optical fiber and said laser source are coupled;
wherein said first optical fiber and said second optical fiber are coupled such that the optical power in said second optical fiber is greater at the output of said second optical fiber than at the input of said second optical fiber.

25. The apparatus of claim 24 wherein said material comprises an element that is selected from the group consisting of ytterbium, erbium, yttrium, lanthanum, samarium, cerium, praseodymium, neodymium, promethium, europium, terbium, holmium, and thulium.

26. The apparatus of claim 24 wherein said first optical fiber comprises said fiber Bragg grating.

27. The apparatus of claim 24 wherein said second optical fiber further comprises said fiber Bragg grating.

28. The apparatus of claim 24 wherein said fiber Bragg grating is non-chirped fiber Bragg grating.

29. The apparatus of claim 24 wherein said fiber Bragg grating is a chirped fiber Bragg grating.
